(19) United States
(12) Patent Application Publication
(10) Pub. No.: US 2009/0239579 A1
(43) Pub. Date: Sep. 24, 2009

(54) MOBILE DEVICE CAPABLE OF SUITABLY DISPLAYING INFORMATION THROUGH RECOGNITION OF USER'S FACE AND RELATED METHOD

(75) Inventors: Jin Gu LEE, Daegu Metropolitan City (KR); Moon Heui LEE, Gumi-si (KR); Yun Hyang KIM, Gumi-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/407,915

(22) Filed: Mar. 20, 2009

(30) Foreign Application Priority Data
Mar. 24, 2008 (KR) 10-2008-0027050

(51) Int. Cl. H04M 1/00; G06K 9/48

(52) U.S. Cl. 455/556.1; 382/199

(57) ABSTRACT

A mobile device and a method that can suitably display information on a display screen in a direction consistent with a user's view according to a rotated position of the mobile device determined through recognition of a user's face are provided. A camera module acquires a user's image including the user's face, and a face recognition unit recognizes the user's face from the user's image. A position determination unit determines a position of the mobile device from a positional relation of the user's face to the user's image. A display controller determines a display direction of the information according to the position of the mobile device, and then controls a display unit to display the information in the display direction.

### PRIORITY

This application claims the benefit under 35 U.S.C. §119(a) of a Korean patent application filed in the Korean Intellectual Property Office on Mar. 24, 2008 and assigned Serial No. 10-2008-0027050, the entire disclosure of which is hereby incorporated by reference.

### BACKGROUND OF THE INVENTION

1. Field of the Invention

The present invention relates generally to an advanced display technique in a mobile device. More particularly, the present invention relates to a mobile device and a method for suitably displaying information in a direction consistent with a user's view.

2. Description of the Related Art

With the advent of new techniques and functions attracting customers' interest, the market of mobile devices is making a rapid and strong growth. Moreover, dramatic advances in mobile communication technology are investing traditional mobile devices with a variety of applications that meet customers' demands. Accordingly, users today of mobile devices come to use information in various forms of voice, text, graphic, etc. and to enjoy music, broadcasts, games, etc.

Since such a mobile device has inherent portability, a user may often easily rotate a mobile device during its use and thus change its position. That is, a display screen of a mobile device may be placed vertically or horizontally with respect to a user's view. However, the direction of information being displayed on a screen is unchanged regardless of the position or orientation of the mobile device. Here, information provided on a screen may include still images, moving images, texts, menus, icons, or any other graphical objects.

The direction in which information is displayed in a mobile device is predefined as a default for the mobile device. Moreover, the direction of information displayed is also fixed. Therefore, a user who orients a mobile device in a position different from the direction in which the information is displayed may suffer an inconvenience when viewing the displayed information. For example, while a user uses a mobile device in a horizontal position, some menu items may be displayed in a vertical direction on a display screen. In this circumstance, a user who intends to select such menu items may rotate the mobile device to be consistent with his view. Additionally, after selecting such menu items, a user may return the mobile device to a horizontal position for use. Accordingly, there is a need for a mobile device and method for suitably displaying information in a direction consistent with a user's view.

### BRIEF SUMMARY OF THE INVENTION

An aspect of the present invention is to address at least the above-mentioned problems and/or disadvantages and to provide at least the advantages described below. Accordingly, an aspect of the present invention is to provide a mobile device and a method that allow ascertaining the position of the mobile device and thereby determining the display direction of information on a screen of the mobile device.

Another aspect of the present invention is to provide a mobile device and a method that allow changing the display direction of information on a screen of the mobile device according to the position of the mobile device.

Still another aspect of the present invention is to provide a mobile device and a method that allow suitably displaying information on a screen of the mobile device to be consistent with a user's view.

According to an aspect of the present invention, a method for displaying information on a mobile device is provided. This method comprises acquiring a user's image including a user's face through a camera module, recognizing the user's face from the user's image, determining a position of the mobile device from a positional relation of the user's face to the user's image and displaying information in a display direction determined according to the position of the mobile device.

According to another aspect of the present invention, a mobile device is provided. The mobile device includes a display unit for displaying information on a screen, a camera module for acquiring a user's image including a user's face, a face recognition unit for recognizing the user's face from the user's image, a position determination unit for determining a position of the mobile device from a positional relation of the user's face to the user's image and a display controller for determining a display direction of information according to the position of the mobile device and for controlling the display unit to display the information in the display direction.

According to yet another aspect of the present invention, a method for displaying information on a mobile device is provided. This method includes acquiring a user's image including a user's face through a camera module, recognizing the user's face from the user's image and displaying information in a display direction consistent with a user's view of the user's face.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a mobile device in accordance with an exemplary embodiment of the present invention;

FIGS. 2 and 3 are flowcharts illustrating a method for suitably displaying information through recognition of a user's face in accordance with an exemplary embodiment of the present invention; and

FIGS. 4 to 7 are views illustrating examples of displaying information in accordance with an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

### Mobile Device

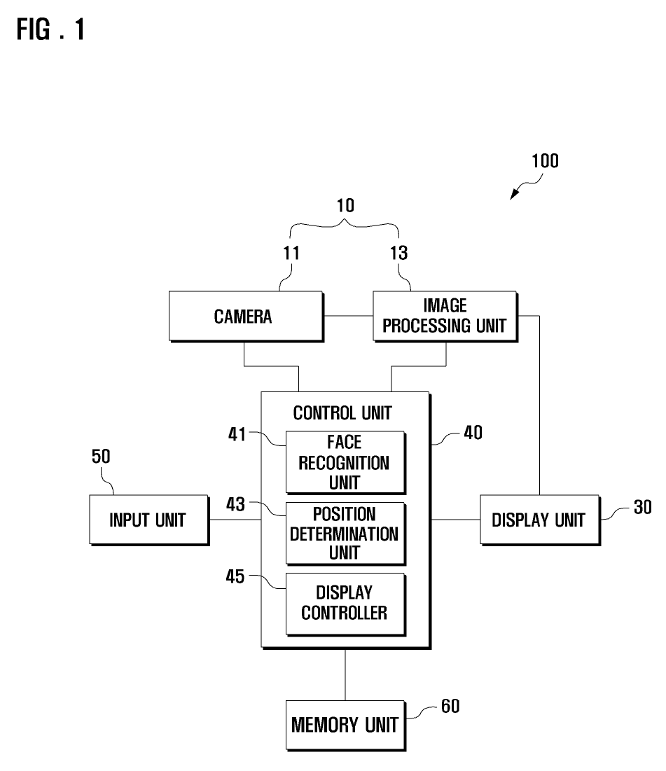

FIG. 1 is a block diagram illustrating a mobile device in accordance with an exemplary embodiment of the present invention.

Referring to FIG. 1, the mobile device 100 includes a camera module 10, a display unit 30, a control unit 40, an input unit 50, and a memory unit 60.

Exemplary embodiments of the present invention may include any kind of a mobile device having a camera lens. For example, the present invention may include a mobile communication device, a Personal Digital Assistant (PDA), a Portable Multimedia Player (PMP), and so forth.

In an exemplary embodiment, the camera module 10 acquires a user's image, which includes a user's face, to determine the position of the mobile device 100. The camera module 10 is composed of a camera 11 and an image processing unit 13.

The camera 11 includes a lens disposed on the mobile device 100. In an exemplary implementation, the lens is disposed on the front side of the mobile device 100. Here, the front side denotes a surface on which the display unit 30 is disposed. Accordingly, the camera 11 may execute a self-shot toward a user. That is, the camera 11 may capture an image of the user upon execution of the camera function by the user, while the user is facing the display unit 30. The camera 11 may also include a lens disposed on the rear side of the mobile device 100. The camera 11 includes an image sensor that converts optical signals into electrical signals, and a signal processor that converts analog signals into digital signals. In an exemplary implementation, with the display unit 30 being enabled, the camera 11 takes a user's image required for determining the position of the mobile device 100.

The image processing unit 13 receives a user's image from the camera 11 and then processes the received image to meet standard requirements of the display unit 30. The image processing unit 13 may edit a user's image under the control of the control unit 40.

The display unit 30 displays information on a screen. Here, information may include still images, moving images, texts, menus, icons, or any other graphical objects. Particularly, when displaying information, the display unit 30 rotates the display direction of information according to the positional relation between the mobile device and a user. More detailed descriptions about this function will be made later. The display unit 30 may employ a Liquid Crystal Display (LCD), a touch screen, or any other alternatives. Among them, a touch screen may execute an input function as well as a display function.

The control unit 40, e.g., a microprocessor, executes a variety of control functions for the mobile device 100. Specifically, the control unit 40 recognizes a user's face from a user's image acquired through the camera module 10, and then determines the position of the mobile device 100 by using the recognized user's face. In addition, depending on the position of the mobile device 100, the control unit 40 determines the display direction of information and then controls the display unit 30 to suitably display information. More detailed descriptions about the control unit 40 will be made later.

The input unit 50 includes a number of alphanumeric keys and function keys arranged for efficient data entry into the mobile device 100. On receipt of a user's key selection, the input unit 50 creates a key selection signal and sends it to the control unit 40. The input unit 50 may employ a keypad, a touchpad, a wheel key, a touch screen and/or any other pointing devices or input devices.

The memory unit 60 stores some programs necessary for controlling the operation of the mobile device 100, and also stores data created while such programs are executed. Specifically, the memory unit 60 stores a face recognition program that executes the recognition of a face from a user's image, and an image display program that executes the determination of the display direction of information and the display of information. The memory unit 60 includes at least one volatile memory device and at least one non-volatile memory device.

The control unit 40 includes a face recognition unit 41, a position determination unit 43, and a display controller 45.

The face recognition unit 41 recognizes a face from an image that the camera module 10 acquires. That is, the face recognition unit 41 detects the contour of a face from a user's image and then ascertains the location of one or more of a pair of eyes, a jaw, a mouth, etc. This face recognition unit 41 may use well-known methods such as an eigenface method using Principle Component Analysis (PCA), a fisherface method using Fisher Linear Discriminant (FLD), a method using PCA and Support Vector Machine (SVM), etc.

The position determination unit 43 determines the position of the mobile device 100 from the positional relation of a recognized face to a datum line of a user's image. That is, depending on the direction of a user's face from the datum line in a user's image, the position determination unit 43 determines the angle of rotation (θ) of the mobile device 100 and thereby determines the position of the mobile device 100.

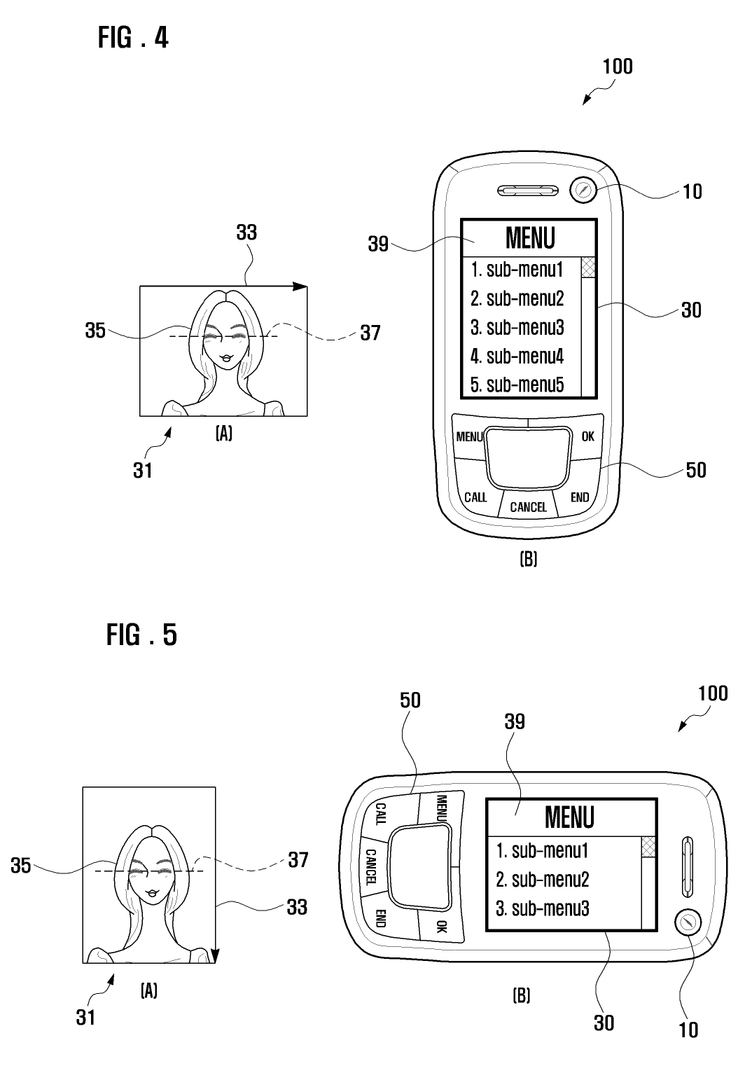

The datum line may be one of four edges of an image, having a rectangular shape, or one of specific lines parallel to four edges. In an example as illustrated in FIGS. 4 to 7, the datum line is the top edge 33 of a user's image 31 when the mobile device 100 is in a normal state, i.e., an upward state. The angle between the datum line and the both-eyes line is defined as the angle of rotation (θ) of the mobile device 100. As indicated by a reference number 37 in FIGS. 4 to 7, the both-eyes line denotes an imaginary line connecting a user's two eyes. In the illustrated example of FIGS. 4 to 7, when the datum line 33 is located above and parallel to the both-eyes line 37, the angle of rotation (θ) of the mobile device 100 is set to zero.

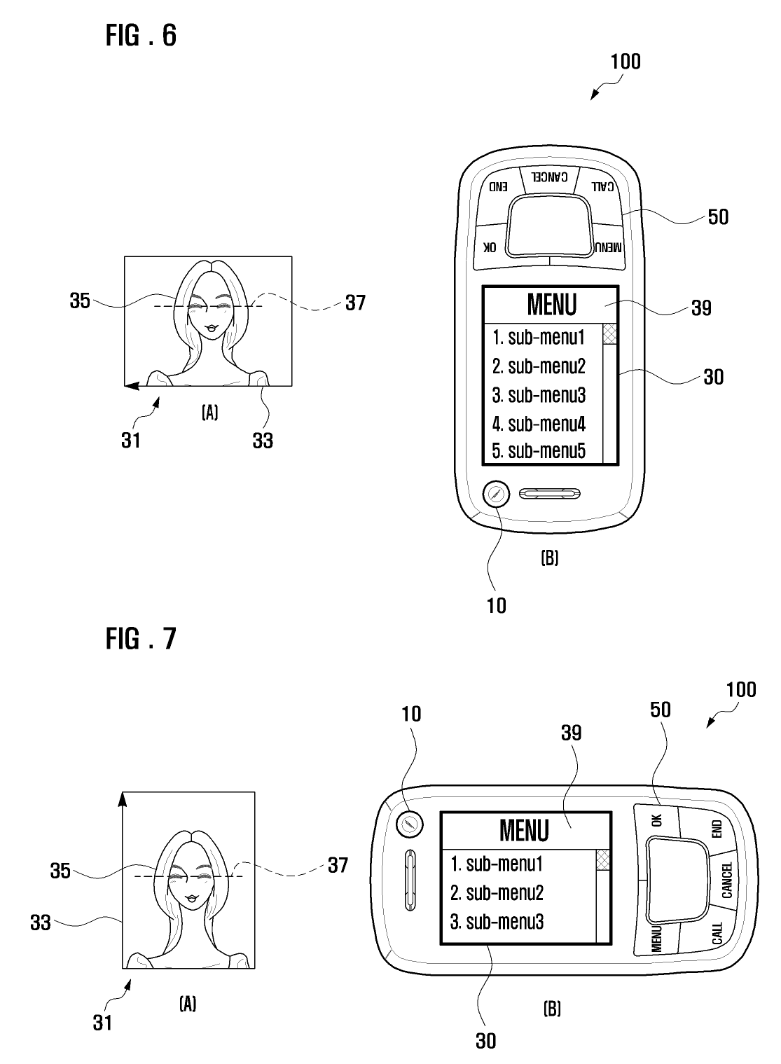

In most cases, the angle of rotation (θ) of the mobile device 100 in use is one of zero degree, 90 degrees, 180 degrees, and 270 degrees. Hereinafter, the positions of the mobile device 100 corresponding to the above angles are referred to as “an upward state”, “a rightward state”, “a downward state”, and “a leftward state”, respectively. FIG. 4 shows “an upward state” of the mobile device 100 in which the display unit 30 is located above the input unit 50. FIG. 5 shows “a rightward state” of the mobile device 100 in which the display unit 30 is located on the right of the input unit 50. FIG. 6 shows “a downward state” of the mobile device 100 in which the display unit 30 is located under the input unit 50. FIG. 7 shows “a leftward state” of the mobile device 100 in which the display unit 30 is located on the left of the input unit 50.

The display controller 45 determines the display direction of information from the position of the mobile device 100 and then controls the display unit 30 to suitably display information depending on the determined direction. That is, corresponding to the angle of rotation (θ) of the mobile device 100, which belongs to a range of (M+90×(N−1))≦θ<(M+90×N) (where 0≦M≦90, N=0,1,2,3), the display controller 45 determines the display direction of information on the display unit 30.

Specifically, if the rotated angle (θ) belongs to the range of M−90≦θ<M (N=0), the position determination unit 43 determines that the mobile device 100 is in an upward state. Here, the display controller 45 enables the display unit 30 to display information 39 in a normal direction, an example of which is illustrated in FIG. 4.

If the rotated angle (θ) belongs to the range of M≦θ<M+90 (N=1), the position determination unit 43 determines that the mobile device 100 is in a rightward state. Here, the display controller 45 enables the display unit 30 to display information 39 in a counterclockwise-rotated direction, an example of which is illustrated in FIG. 5.

If the rotated angle (θ) belongs to the range of M+90≦θ<M+180 (N=2), the position determination unit 43 determines that the mobile device 100 is in a downward state. Here, the display controller 45 enables the display unit 30 to display information 39 in a reverse direction, an example of which is illustrated in FIG. 6.

If the rotated angle (θ) belongs to the range of M+180≦θ<M+270 (N=3), the position determination unit 43 determines that the mobile device 100 is in a leftward state. Here, the display controller 45 enables the display unit 30 to display information 39 in a clockwise-rotated direction, an example of which is illustrated in FIG. 7.

On the other hand, if the value of M is very small, even a slight rotation of the mobile device 100 may rotate the display direction of information. Since this may cause an inconvenience to a user, it is preferable that the value of M is selected from 45 to 90.

As an example, it is assumed that the value of M is 45. If the rotated angle (θ) belongs to the range of −45≦θ<45, the display controller determines that the display direction of information is normal. Thereafter, if the mobile device begins to rotate clockwise and then passes through an angle of 45 degrees, the display controller rotates the display direction of information to a 90-degree counterclockwise angle. That is, just as the rotated angle (θ) of the mobile device goes into the range of 45≦θ<135, the display controller forces the display unit to display information by a 90-degree counterclockwise rotation. Contrary to the above, if the mobile device begins to rotate counterclockwise and then passes through an angle of −45 degrees, the display controller rotates the display direction of information to a 90-degree clockwise angle. That is, just as the rotated angle (θ) of the mobile device goes into the range of 225≦θ<315, the display controller forces the display unit to display information by a 90-degree clockwise rotation.

As discussed above, when the mobile device 100 is in an upward state, information is displayed normally on the display unit. However, when the mobile device 100 is in another state, the display controller 45 controls the display direction of information to be rotated suitably depending on the position of the mobile device 100. Accordingly, regardless of the position of the mobile device 100, information can always be displayed in a convenient direction for a user's view.

Although the mobile device 100 in this exemplary embodiment executes essential functions of face recognition and position determination through the control unit 40, the present invention may not be limited to this. Alternatively, such functions may be executed through the image processing unit 13 of the camera module 10.

In addition to the aforesaid elements, the mobile device 100 of the present invention may further include other suitable elements, for example, a Radio Frequency (RF) unit for voice calls, image calls, and message communications, a short-distance wireless communication unit such as Bluetooth, a Global Positioning System (GPS) unit, a digital broadcasting receiver unit, etc.

### Information Display Method

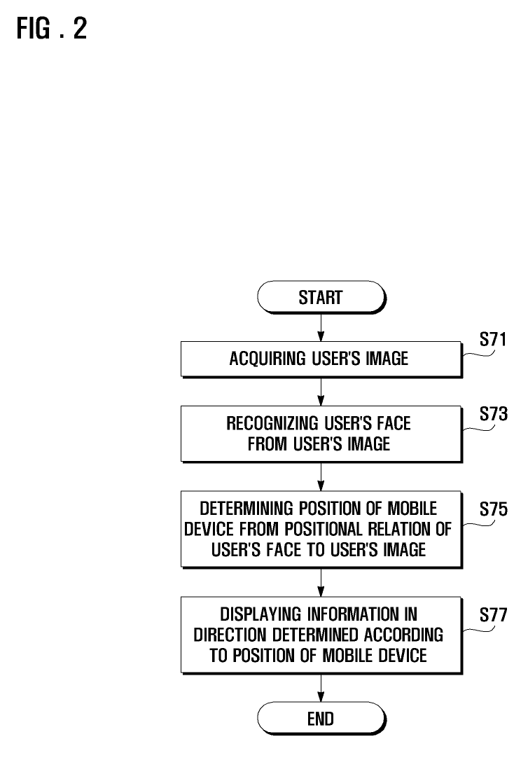

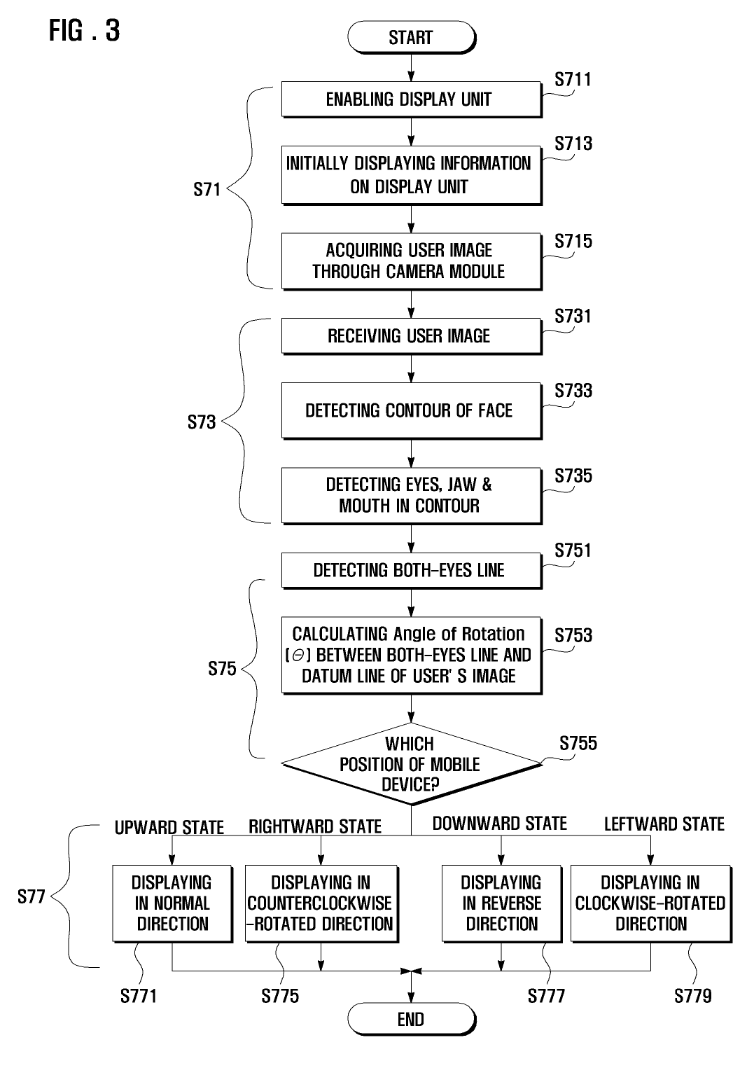

FIGS. 2 and 3 are flowcharts illustrating a method for suitably displaying information through recognition of a user's face in accordance with an exemplary embodiment of the present invention.

Referring to FIGS. 1 to 3, in step S71, the camera module 10 acquires a user's image through a self-shot toward the user. Specifically, and with reference to FIG. 3 which provides a more detailed explanation of the process of FIG. 2, the display unit 30 is enabled in step S711, and the display controller 45 controls the display unit 30 to initially display information on a screen in step S713. Then, to adjust the display direction of information according to the positional relation between the mobile device and the user, the camera module 10 takes the user's image including the user's face in step S715.

In the aforesaid step S711, the display unit 30 may be enabled according to a user's key input or any other alternative actions such as opening of a folder or a slide of the mobile device 100. In the aforesaid step S713, the display unit 30 may be controlled to initially display information in a normal direction. Alternatively, the display controller 45 may preset the initial display direction of information by a selected one of other directions or by the last direction just before the display unit 30 was previously disabled.

Next, in step S73, the face recognition unit 41 recognizes the user's face from the acquired user's image. Specifically, the face recognition unit 41 receives the acquired user's image from the camera module 10 in step S731. Then, the face recognition unit 41 detects the contour of a face from the received user's image in step S733, and also detects the location of one or more of a pair of eyes, a jaw, a mouth, and the like in the detected contour in step S735.

Next, in step S75, the position determination unit 43 determines the position of the mobile device 100 from the positional relation of a user's face to a datum line of a user's image. More specifically, the position determination unit 43 detects the both-eyes line from a user's face in step S751, and determines the angle of rotation (θ) formed by the both-eyes line and the datum line of a user's image in step S753. Then, depending on the angle of rotation (θ), the position determination unit 43 determines the relative position of the mobile device 100 from a user's view in step S755.

For example, if the angle of rotation (θ) belongs to the range of M−90≦θ<M (N=0), the position determination unit 43 determines that the mobile device 100 is in an upward state. Furthermore, if the angle of rotation (θ) belongs to the range of M≦θ<M+90 (N=1), the position determination unit 43 determines that the mobile device 100 is in a rightward state. Similarly, if the angle of rotation (θ) belongs to the range of M+90≦θ<M+180 (N=2), the position determination unit 43 determines that the mobile device 100 is in a downward state. Finally, if the angle of rotation (θ) belongs to the range of M+180≦θ<M+270 (N=3), the position determination unit 43 determines that the mobile device 100 is in a leftward state.

After the position of the mobile device 100 is determined, in step S77 the display controller 45 determines the display direction of information, depending on the position of the mobile device 100, and then controls the display unit 30 to display information on a screen according to the determined direction.

For example, if the mobile device 100 is in an upward state, in step S771 the display controller 45 enables the display unit 30 to display information in a normal direction.

If the mobile device 100 is in a rightward state, in step S775 the display controller 45 enables the display unit 30 to display information in a counterclockwise-rotated direction.

If the mobile device 100 is in a downward state, in step S777 the display controller 45 enables the display unit 30 to display information in a reverse direction.

If the mobile device 100 is in a leftward state, in step S779 the display controller 45 enables the display unit 30 to display information in a clockwise-rotated direction.

As discussed above, the display controller 45 controls the display direction of information according to the position of the mobile device 100 so that information can be always displayed in a convenient direction for a user's view.

### DISPLAY EXAMPLES

FIGS. 4 to 7 are views that illustrate examples of displaying information in accordance with an exemplary embodiment of the present invention.

In these examples, the datum line 33 is assigned to the top edge of a user's image 31 taken by the camera module 10 when the mobile device 100 is in an upward state as shown in FIG. 4. In FIGS. 4 to 7, the datum line 33 is represented by a relatively thick arrow for distinction from the other edges. Additionally, when the datum line 33 is located above and parallel to the both-eyes line 37, the rotated angle (θ) of the mobile device 100 is set to zero as shown in FIG. 4. FIGS. 5 to 7 show other states in which the rotated angle (θ) of the mobile device 100 is 90 degrees, 180 degrees, and 270 degrees, respectively. The value of M in the aforesaid equation regarding the rotated angle (θ) is 45 in these examples. Furthermore, the menu information 39, displayed on the display unit 30, is used merely as an example.

The leftmost image (A) of FIG. 4 shows a user's image 31 taken by the camera module 10 and including a user's face 35. As described above, the position determination unit determines the position of the mobile device 100 from the positional relation of a user's face 35 to the datum line 33 of a user's image 31. That is, since the datum line 33 is located above and parallel to the both-eyes line 37 of a user's face 35, the position determination unit determines that the angle of rotation (θ) is zero. Additionally, since this angle of rotation (θ) belongs to the range of −45≦θ<45, the position determination unit determines that the mobile device 100 is in an upward state.

The rightmost image (B) of FIG. 4 shows the mobile device 100 including the display unit 30 in an upward state. To correspond to the upward state, the display controller controls the display unit 30 so that a menu 39 is displayed in a normal direction.

FIG. 5 shows the case in which the mobile device 100 of FIG. 4 is rotated to a 90-degree clockwise angle. As shown in the leftmost image (A) of FIG. 5, since the datum line 33 is located on the right of and perpendicular to the both-eyes line 37 of a user's face 35, the position determination unit determines that the angle of rotation (θ) is 90 degrees. Additionally, since this angle of rotation (θ) belongs to the range of 45≦θ<135, the position determination unit determines that the mobile device 100 is in a rightward state.

Furthermore, as shown in the rightmost image (B) of FIG. 5, the display controller controls the display unit 30 so that a menu 39 is displayed in a counterclockwise-rotated direction to correspond to the rightward state. Accordingly, the display direction of a menu 39 is consistent with a user's view.

FIG. 6 shows the case in which the mobile device 100 of FIG. 4 is rotated to a 180-degree angle. As shown in the leftmost image (A) of FIG. 6, since the datum line 33 is located under and parallel to the both-eyes line 37 of a user's face 35, the position determination unit determines that the angle of rotation (θ) is 180 degrees. Additionally, since this angle of rotation (θ) belongs to the range of 135≦θ<225, the position determination unit determines that the mobile device 100 is in a downward state.

Furthermore, as shown in the rightmost image (B) of FIG. 6, the display controller controls the display unit 30 so that a menu 39 is displayed in a reverse direction to agree with a downward state. Accordingly, the display direction of a menu 39 is consistent with a user's view.

FIG. 7 shows the case in which the mobile device 100 of FIG. 4 is rotated to a 270-degree clockwise angle or to a 90-degree counterclockwise angle. As shown in the leftmost image (A) of FIG. 7, since the datum line 33 is located on the left of and perpendicular to the both-eyes line 37 of a user's face 35, the position determination unit determines that the angle of rotation (θ) is 270 degrees. Additionally, since this angle of rotation (θ) belongs to the range of 225≦θ<315, the position determination unit determines that the mobile device 100 is in a leftward state.

Furthermore, as shown in the rightmost image (B) of FIG. 7, the display controller controls the display unit 30 so that a menu 39 is displayed in a clockwise-rotated direction to agree with a leftward state. Accordingly, the display direction of a menu 39 is consistent with a user's view.

As discussed heretofore, the mobile device according to an exemplary embodiment of the present invention recognizes a user's face from a user's image acquired by the camera module and thereby determines its position and the display direction of information. Therefore, depending on the position of the mobile device in use, information displayed on the display unit is changed in direction. That is, regardless of the position of the mobile device, information can always be displayed in a proper direction for a user's view.

Accordingly, the mobile device of this invention may enhance a user's convenience. Moreover, to ascertain the position in use, the mobile device according to an exemplary embodiment of the present invention uses the camera module, typically equipped therein, and a face recognition program only. Therefore, this mobile device does not require additional hardware, such as an accelerometer, and thereby can avoid the complexity of circuits due to addition of hardware.

While this invention has been particularly shown and described with reference to exemplary embodiments thereof, it will be understood by those skilled in the art that various changes in form and details may be made therein without departing from the spirit and scope of the invention as defined by the appended claims and their equivalents.

What is claimed is:

1. A method for displaying information on a mobile device, the method comprising:
acquiring a user's image including a user's face through a camera module;
recognizing the user's face from the user's image;
determining a position of the mobile device from a positional relation of the user's face to the user's image; and
displaying information in a display direction determined according to the position of the mobile device.

2. The method of claim 1, wherein the display direction of the information comprises a direction corresponding to the user's view.

3. The method of claim 1, wherein the recognizing of the user's face comprises:
detecting a contour of the user's face from the user's image; and
detecting a location of at least one of a pair of eyes, a jaw, and a mouth in the contour of the user's face.

4. The method of claim 1, wherein the determining of the position of the mobile device comprises determining an angle of rotation (θ) of the mobile device from a relative location of the user's face to a datum line in the user's image.

5. The method of claim 4, wherein the datum line comprises at least one of an edge of the user's image, the user's image having a rectangular shape, and a line parallel to an edge.

6. The method of claim 3, wherein the determining of the position of the mobile device comprises:
detecting a both-eyes line from the detected eyes of the user's face;
determining an angle of rotation (θ) of the mobile device, the angle of rotation (θ) being formed by the both-eyes line and a datum line in the user's image; and
determining the position of the mobile device corresponding to the angle of rotation (θ) which belongs to a range of (M+90×(N−1))≦θ<(M+90×N) (where 0≦M≦90, N=0,1,2,3).

7. The method of claim 6, wherein the displaying of the information comprises:
if the angle of rotation (θ) belongs to the range of M−90≦θ<M, displaying the information in a normal direction;
if the angle of rotation (θ) belongs to the range of M≦θ<M+90, displaying the information in a counterclockwise-rotated direction;
if the angle of rotation (θ) belongs to the range of M+90≦θ<M+180, displaying the information in a reverse direction; and
if the angle of rotation (θ) belongs to the range of M+180≦θ<M+270, displaying the information in a clockwise-rotated direction.

8. The method of claim 7, wherein the value of M is selected from 45 to 90 degrees.

9. The method of claim 1, wherein the information comprises at least one of a still image, a moving image, a text, a menu, an icon, and a graphical object.

10. A mobile device comprising:
a display unit for displaying information on a screen;
a camera module for acquiring a user's image including a user's face;
a face recognition unit for recognizing the user's face from the user's image;
a position determination unit for determining a position of the mobile device from a positional relation of the user's face to the user's image; and
a display controller for determining a display direction of information according to the position of the mobile device and for controlling the display unit to display the information in the display direction.

11. The mobile device of claim 10, wherein the display controller determines the display direction of the information corresponding to the user's view.

12. The mobile device of claim 10, wherein the face recognition unit detects a contour of the user's face from the user's image and further detects a location of at least one of a pair of eyes, a jaw, and a mouth in the contour of the user's face.

13. The mobile device of claim 10, wherein the position determination unit determines an angle of rotation (θ) of the mobile device from a relative location of the user's face to a datum line in the user's image.

14. The mobile device of claim 13, wherein the datum line comprises at least one of an edge of the user's image, the user's image having a rectangular shape, and a line parallel to an edge.

15. The mobile device of claim 12, wherein the position determination unit detects a both-eyes line from the detected eyes of the user's face, determines an angle of rotation (θ) of the mobile device, the angle of rotation (θ) being formed by the both-eyes line and a datum line in the user's image, and determines the position of the mobile device corresponding to the angle of rotation (θ) which belongs to a range of (M+90×(N−1))≦θ<(M+90×N) (where 0≦M≦90, N=0,1,2,3).

16. The mobile device of claim 15, wherein the display controller controls the display unit to display the information in a normal direction if the angle of rotation (θ) belongs to the range of M−90≦θ<M, in a counterclockwise-rotated direction if the angle of rotation (θ) belongs to the range of M≦θ<M+90, in a reverse direction if the angle of rotation (θ) belongs to the range of M+90≦θ<M+180, and in a clockwise-rotated direction if the angle of rotation (θ) belongs to the range of M+180≦θ<M+270.

17. The mobile device of claim 16, wherein the value of M is selected from about 45 to 90 degrees.

18. The mobile device of claim 10, wherein the information comprises at least one of a still image, a moving image, a text, a menu, an icon, and a graphical object.

19. A method for displaying information on a mobile device, the method comprising:
acquiring a user's image including a user's face through a camera module;
recognizing the user's face from the user's image; and
displaying information in a display direction consistent with a user's view of the user's face.

20. The method of claim 19, further comprising:
determining a position of the mobile device from a positional relation of the user's face to the user's image,
wherein the display direction is determined according to the position of the mobile device.
